(19) United States
(12) Patent Application Publication
(10) Pub. No.: US 2014/0095224 A1
(43) Pub. Date: Apr. 3, 2014

(54) REDUCING SELECTON UNCERTAINTY OF OPAQUE SALES OF TRAVEL PRODUCTS

(71) Applicant: GetGoing, Inc., San Francisco, CA (US)

(72) Inventors: Alek Vernitsky, San Francisco, CA (US); Ilya Gluhovsky, Daly City, CA (US); Alek Strygin, Foster City, CA (US)

(21) Appl. No.: 14/042,138

(22) Filed: Sep. 30, 2013

Related U.S. Application Data
(60) Provisional application No. 61/708,490, filed on Oct. 1, 2012.

(51) Int. Cl. G06Q 10/02

(52) U.S. Cl. CPC G06Q 10/02
USPC 705/5

(57) ABSTRACT

The disclosed embodiments provide a system that facilitates an opaque purchase that obscures one or more details of a travel product. Upon receiving a commitment to make the opaque purchase of the travel product by a user, the system presents the user with a set of purchase options associated with the opaque purchase, wherein the set of purchase options includes a first purchase option that conforms to one or more terms of the opaque purchase. Next, the system obtains, from the user, a selection of a purchase option from the set of purchase options. Finally, the system processes the opaque purchase with the selection.

### RELATED APPLICATION

This application claims the benefit of U.S. Provisional Application No. 61/708,490, Attorney Docket Number GG12-1002PSP, entitled “Method and Apparatus for Reducing Selection Uncertainty of Opaque Sales,” by inventors Alek Vernitsky, Ilya Gluhovsky and Alek Strygin, filed 1 Oct. 2012, which is incorporated herein by reference.

### BACKGROUND

1. Field

The disclosed embodiments relate to market segmentation and price differentiation. More specifically, the disclosed embodiments relate to techniques for reducing the selection uncertainty of opaque sales of travel products.

2. Related Art

Differential pricing, which includes product differentiation and price discrimination, is a pricing strategy commonly used by businesses for selling products like airline seats, hotel rooms, and/or other travel products. Differential pricing is used to sell the right number of products to targeted customers for an appropriate price in order to maximize profit from a fixed, perishable resource. Price discrimination or price differentiation refers to the practice of charging different prices for the same (or very similar) products that have the same costs of production, based solely on different consumers' willingness to pay (WTP). Product discrimination, on the other hand, involves charging different prices for products with different quality of service characteristics and, in general, different costs of production. Revenue systems utilize both price discrimination and product differentiation in an attempt to maximize yield. They offer a variety of products, involving differences in the quality of services, as well as differences in the purchase according to conditions and restrictions.

A related strategy is market segmentation, which refers to classifying individuals or identifying different demand groups or segments. Market segmentation techniques are used in order to maximize revenues from sale of a fixed, perishable commodity, such as a seat on an airline, a hotel room, cruises, car rental, or any other such products. In theory, total revenue from a product is maximized when each consumer pays a different price equal to his or her WTP. In practice, such a theoretical segmentation cannot be achieved as the system cannot determine each individual WTP for each particular product, nor can it publish different prices available only to specific individuals.

FIG. 1A illustrates a price demand curve used for price differentiation in airlines. The entire area under the sloping line represents the maximum revenue that an airline may derive from a given flight. If the airline offers an unrestricted fare P1 (price) to those consumers with a higher WTP, the airline can expect Q1 (quantity) consumers to purchase the fare because they have WTP equal to P1 or greater. However, the airline may leave a lot of revenue on the table, both because it did not charge a higher price for those consumers who have WTP>P1, and also because a number of seats are flying empty, as many consumers with WTP<P1 did not buy a ticket.

FIG. 1B illustrates a graphical representation of a typical differential pricing technique of a product. If the airline offers a lower or discount fare P2 to those consumers with a lower WTP, then Q2-Q1 additional consumers would be expected to purchase the lower fare, as they have WTP greater than P2 but less than P1. By introducing two fares, the airline is able to capture a greater portion of the total available revenue. This model assumes that consumers with a high WTP purchase the higher fare P1. Price discrimination presents a challenge of identifying and segmenting customers based on the strength of their preference for a specific product. Without it, profit/yield and market reach of a product are reduced.

For example, consumers prefer high-quality goods over low-quality goods, if prices for all goods are the same. By introducing products of different quality and at different prices, the airlines try to segment the market into consumers with higher and lower WTP. First class, business, premium economy, and economy cabins, as well as tickets that come with expedited security services, priority boarding, and lounge access, are all examples of product differentiation. Furthermore, fare classes and fare basis codes are the most important yield management innovation introduced by the airlines. Fare basis codes are used for selling less desirable flights cheap more cheaply, such as those flying mid-week or off-season, in combination with booking classes, as well as imposing fare rule penalties on refunds and/or exchanges, thus constituting product differentiation. On the other hand, two prime examples of price discrimination, also often achieved using fare basis codes, are providing corporate discounts and (separately) imposing an advanced purchase restriction. Thus, corporate customers often get a price break on the same product thanks to the volume sales a corporation achieves. Similarly, the same seat being sold far in advance is typically cheaper than that sold last minute. A typical problem with the latter strategy is that it locks out prospective low-WTP customers who were unable or unwilling to commit to travel in advance while precluding an airline from dropping last-minute prices, so that business customers stepping on a plane at the last minute do not catch the same price break and discretionary customers do not develop a habit of buying cheap travel late.

There are other approaches used by airline service providers to sell tickets with offers which yield profits and also optimize the revenue and managing inventory for the airline, thus ensuring to supply consumers with the best products for which they are willing to pay. For example, a prospective purchaser purchasing an airline ticket may commit to purchasing an airline ticket at a reduced price, but the transaction may only occur if the seller makes the ticket available at a designated time near the date of departure. In such scenarios, the utility in a commercial sale of airline tickets is limited. First, the buyer is required to make a commitment in advance without any certainty of getting on a flight.

Second, the buyer is effectively precluded from booking a hotel at his chosen destination because of the uncertainty that the trip will occur, and booking a last-minute hotel may offset any savings from the discounted airfare. Third, on routes with frequent last-minute seat availability, many buyers are likely to adjust their behavior and postpone the full price purchase in favor of an acquisition uncertainty ticket. This creates more empty seats and perpetuates a vicious cycle. Thus, the consumer is not sure whether the ticket will be booked or not till near the date of departure.

Another approach of revenue management by airlines is, for example, a Name-Your-Own-Price® (NYOP®) distribution platform that sells opaque fares through buyer-driven pricing. In this NYOP platform (also referred to as the “Priceline® system”), a customer makes a conditional purchase offer by specifying some characteristics of the itinerary (such as origin, destination, and dates) and the price he/she is willing to pay. The request is a commitment by the customer to buy at the offered price. Once the request is made, the Priceline® system searches for an airline that is willing to sell a flight ticket below that price and sends an accept/reject decision back to the customer within a specific time period. If the airline accepts the offer (i.e., a fare exists at or below the buyer-requested price), the flight is booked and the customer is charged. Priceline® keeps the margin between the customer-quoted price and the airline price.

Hotwire® offers a platform where, instead of buyer-driven pricing, the price is disclosed upfront, while the details of the itinerary remain opaque until after the purchase. The opaque sales channels are inferior, both from the airline perspective and from the customer perspective. The opaqueness of the fare downgrades the product by making it less valuable in an attempt to discourage consumption by the high-WTP customers. NYOP® customers must accept considerable uncertainty over the details of their itinerary, including not knowing the airline they will fly, the number of connections, or the exact times of arrival and departure.

In the Priceline® system's implementation, customers are also required to guess the price of an airline ticket and, in an attempt to discourage repeat bidding, wait for a period of time before making another offer. Thus, a buyer may be required to spend a considerable amount of time only to end up with a suboptimal product. In addition, many high-WTP customers exhibit low-WTP behavior. While some business and leisure travelers are likely to be discouraged by the deliberate uncertainty introduced into the transaction (in terms of arrival time, routing, and number of stops), others will perceive the opaque fare as a perfect substitute for the non-opaque fare that allows the buyer to travel from origin to destination and return on the specified dates, resulting in the cannibalization of high-WTP fares, including business fares.

Prepaid airline tickets are made available for purchase in advance of the flights so that the buyer may convert to a specific flight itinerary shortly before the departure, within certain specified parameters (such as a range of dates, a type of seat, etc.), and subject to seat availability. Unlike the unspecified-time ticket, the buyer is not forced to accept whatever flight and seat the airline offers, and has more flexibility to choose within a range of seats available at the very last minute. For both seller- and buyer-driven prepaid tickets, the buyer does not have the certainty of ticket availability until the last minute. Also, the itinerary is either opaque (some but not all of its attributes are known) or, if not opaque, may present the buyer with a limited selection of last-minute unsatisfactory choices. Hence, there remains a need for market segmentation and consequent price differentiation while balancing the interests of the airline and/or travel website, where customers are likely to pay close to their individual WTP, with those of a customer, who is least inconvenienced by the price discrimination mechanism.

### SUMMARY

The disclosed embodiments provide a system that facilitates an opaque purchase that obscures one or more details of a travel product. Upon receiving a commitment to make the opaque purchase of the travel product by a user, the system presents the user with a set of purchase options associated with the opaque purchase, wherein the set of purchase options includes a first purchase option that conforms to one or more terms of the opaque purchase. Next, the system obtains, from the user, a selection of a purchase option from the set of purchase options. Finally, the system processes the opaque purchase with the selection.

In some embodiments, the system also selects the set of purchase options based on one or more attributes associated with the travel product.

In some embodiments, the one or more attributes include at least one of a price, a location, a quality, a brand, a type, an amenity, a supplier, and/or a schedule associated with the travel product. The attributes may also include the availability of each of the purchase options and/or a preference of the user.

In some embodiments, the set of purchase options includes a second purchase option with a premium price that is higher than the price of the first purchase option.

In some embodiments, selecting the set of purchase options based on the one or more attributes involves varying an attribute from the one or more attributes across the set of purchase options. For example, purchase options for flights may vary in price, duration, number of stops, connection points, operating airlines, marketing airlines, departure time, connection time, and/or arrival time. Similarly, purchase options for hotel rooms may vary in price, star rating, location, amenities, and/or hotel room types.

In some embodiments, presenting the user with the set of purchase options involves presenting differences in the one or more attributes among the set of purchase options to the user. For example, the user may be presented with different prices, qualities, locations, amenities, and/or schedules for the purchase options. The user may also be allowed to indicate which attributes to differentiate across as a user preference.

In some embodiments, the system also indicates a number of the purchase options or a differentiating attribute of the purchase options to the user prior to receiving the commitment to make the opaque purchase from the user.

In some embodiments, the set of purchase options includes a second purchase option that is associated with at least one of:

(i) additional information from the user;

(ii) a referral from the user; and

(iii) promotion of the second purchase option by the user.

In some embodiments, the travel product is a flight, a hotel, a rental car, a cruise, a tour, and/or a travel package.

### BRIEF DESCRIPTION OF THE FIGURES

FIG. 1A illustrates a price demand curve used for price differentiation in airlines in accordance with the disclosed embodiments.

FIG. 1B illustrates a graphical representation of a typical differential pricing technique of a product in accordance with the disclosed embodiments.

FIG. 2 shows a schematic of a system in accordance with the disclosed embodiments.

FIG. 3A shows an exemplary screenshot in accordance with the disclosed embodiments.

FIG. 3B shows an exemplary screenshot in accordance with the disclosed embodiments.

FIG. 4 shows a flowchart illustrating the process of facilitating an opaque purchase that obscures one or more details of a travel product in accordance with the disclosed embodiments.

FIG. 5 shows a computer system in accordance with the disclosed embodiments.

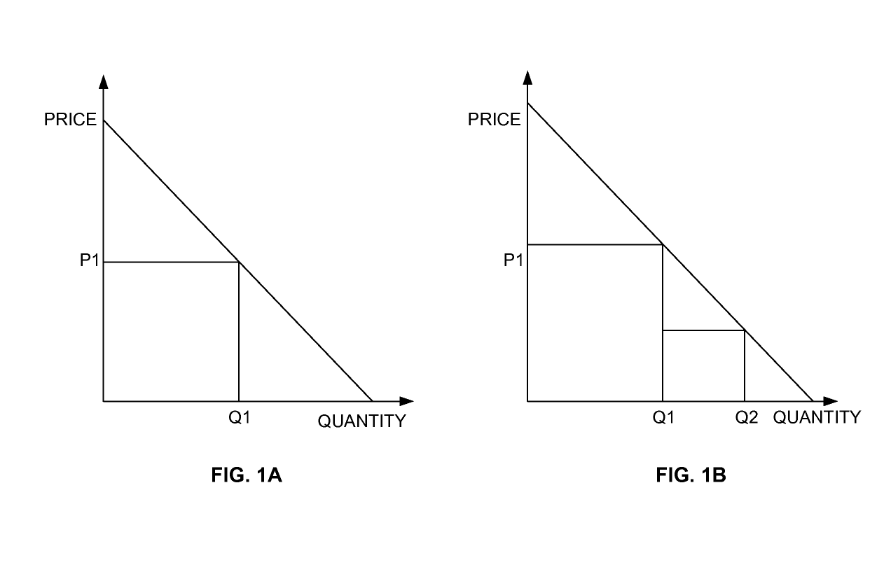

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

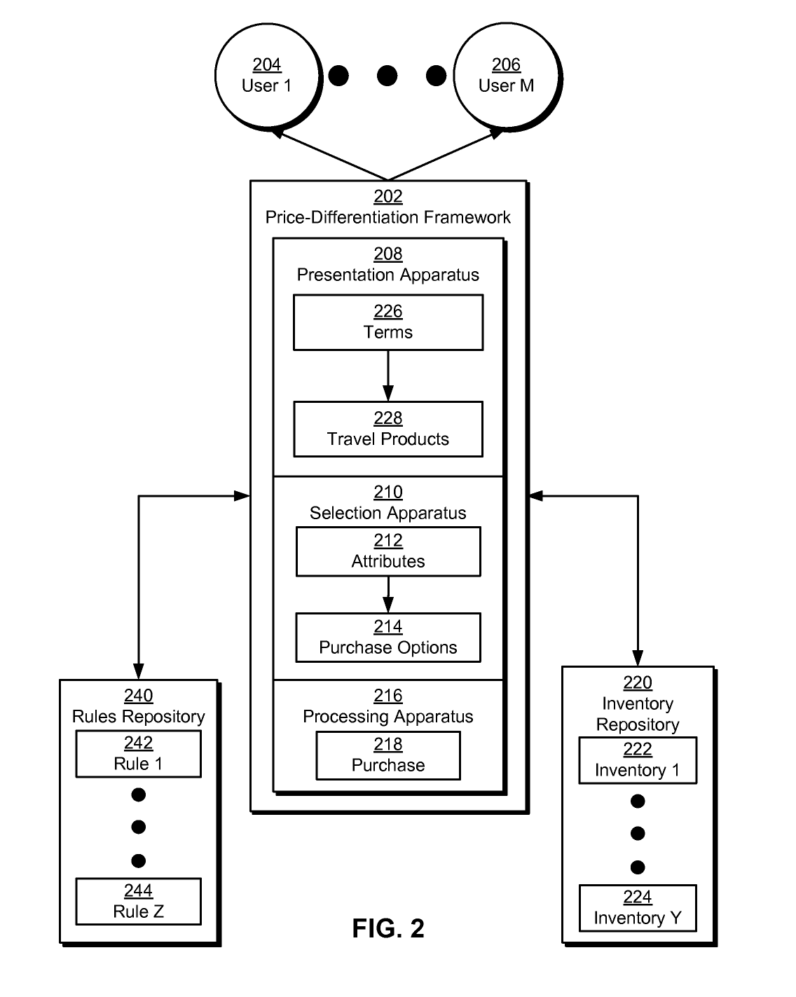

The disclosed embodiments provide a method and system for facilitating the purchase of travel products such as flights, hotels, rental cars, cruises, tours, and/or travel packages. As shown in FIG. 2, the system may correspond to a price-differentiation framework 202 that is accessed by a set of users (e.g., user 1 204, user m 206), also referred to as “buyers.” Price-differentiation framework 202 includes a presentation apparatus 208, a selection apparatus 210, and a processing apparatus 216. Each of the components of price-differentiation framework 202 is described below.

In one or more embodiments, price-differentiation framework 202 allows the users to find and purchase travel products 228. For example, price-differentiation framework 202 may provide a website for browsing, searching, and/or booking flights, hotels, rental cars, cruises, tours, and/or travel packages. Price-differentiation framework 202 may also be accessed through a natively installed application on an electronic device such as a mobile phone, tablet computer, portable media player, laptop computer, and/or personal computer, in lieu of or in addition to the web-based user interface provided by the website.

During use of price-differentiation framework 202, a user may specify a set of criteria associated with booking travel products 228. For example, the user may specify travel dates, locations, price ranges, star ratings, user ratings, names, reward programs, and/or features or amenities associated with one or more types of travel products 228 to be purchased through price-differentiation framework 202. Presentation apparatus 208 may match available inventory (e.g., inventory 1 222, inventory y 224) of travel products 228 from an inventory repository 220 to the criteria and provide the matching travel products 228 to the user. For example, presentation apparatus 208 may use one or more application-programming interfaces (APIs) to query one or more providers of travel products (e.g., airlines, hotels, rental car companies, cruise companies, tour companies, etc.) and/or databases for travel products 228 matching the criteria. Presentation apparatus 208 may then list the matching travel products within a website, mobile application, and/or other mechanism for interacting with the user.

The user may then select a travel product within presentation apparatus 208 for booking, and processing apparatus 216 may process a purchase 218 of the travel product by the user. For example, presentation apparatus 208 and/or processing apparatus 216 may confirm the details of purchase 218 (e.g., dates, locations, prices, amenities, etc.) with the user, obtain payment (e.g., credit card, debit card, electronic check, online payment) information from the user, and perform purchase 218 by booking the travel product using the payment information.

In addition, price-differentiation framework 202 may include functionality to perform opaque sales of travel products 228 in inventory repository 220. More specifically, presentation apparatus 208 may obtain one or more terms 226 of an opaque purchase (e.g., purchase 218) from the user. For example, presentation apparatus 208 may allow the user to specify a set of travel dates, a star rating, a city, a region within the city, and/or a price for a hotel booking to be conducted using the opaque purchase. Next, presentation apparatus 208 may provide one or more travel products 228 matching terms 226 to the user without disclosing one or more identifying details of travel products 228. Continuing with the above example, presentation apparatus 208 may initially withhold the names or addresses of hotels that match the user's terms. Instead, presentation apparatus 208 may disclose the name and location of a hotel only after the user has committed to booking the hotel.

In exchange for the opacity, price-differentiation framework 202 may offer travel products 228 at a discount over the regular prices of travel products 228. For example, price-differentiation framework 202 may allow a user to book a four-star hotel at a price that is normally associated with a three-star hotel. In other words, price-differentiation framework 202 may present a hurdle that constitutes a commitment to purchase 218 a travel product without knowing the identifying details of the travel product. The hurdle may thus segment the market into users who need to know the details of the travel product and are willing to pay the regular price of the travel product and users who are willing to commit to an opaque purchase without knowing the details of the travel product in exchange for a discount. Such segmentation may allow suppliers of travel products to offer lower price points to users in the second category and facilitate the sale of excess inventory while continuing to sell to users in the first category at the normal, higher price point.

On the other hand, users faced with purchase decisions of opaque purchases may face selection uncertainty regarding key attributes (e.g., attributes 212) of the corresponding travel products. For example, an opaque purchase of a flight may withhold the flight's duration and the number of stops, while an opaque purchase of a hotel room may obscure the name of the hotel and/or detailed amenity information associated with the hotel and/or hotel room. As a result, the space of potential outcomes is so broad that a user considering an opaque purchase may incur a large risk factor that is difficult to assess. For example, the user may assess the risk of committing to an opaque purchase of a hotel room by assembling a comprehensive list of all hotels that may fall under the opaque purchase, then manually researching the details of each hotel in the list. Such risk and/or overhead may deter the user from using opaque purchase mechanisms to purchase or book travel products through price-differentiation framework 202.

In one or more embodiments, price-differentiation framework 202 mitigates such selection uncertainty and/or risk by providing multiple purchase options 214 associated with an opaque purchase after the user has committed to making the opaque purchase. Purchase options 214 may include the travel product initially offered in the opaque purchase, as well as one or more other travel products with attributes 212 that may differ from one or more terms 226 of the opaque purchase. In particular, selection apparatus 210 may select purchase options 214 based on attributes 212 and/or a set of rules (e.g., rule 1 242, rule z 244) from a rules repository 240. Attributes 212 may include prices, locations, qualities, brands, types, amenities, suppliers, and/or schedules associated with travel products 228. Attributes 212 may also include an availability of purchase options 214 and/or the user's preferences.

Rules from rules repository 240 may describe the applicability of travel products as purchase options 214 based on attributes 212 of travel products 228 and terms 226. The rules may thus specify the amount by which the attributes of each purchase option must match or differ from terms 226 and/or the number of purchase options 214 to be provided. For example, the rules may populate purchase options 214 with higher-priced travel products than the travel product initially offered in the opaque purchase. The rules may also vary the locations, qualities, amenities, suppliers, schedules, and/or other attributes 212 of purchase options 214 to provide differentiated purchase options 214 to the user. The rules may further allow the user to specify the attributes across which purchase options 214 are varied. The rules may be provided by suppliers of the premium travel products (e.g., hotels, car rental companies, cruise companies, tour companies, airlines, etc.) and/or price-differentiation framework 202 and aggregated in rules repository 240 for subsequent use by price-differentiation framework 202.

Presentation apparatus 208 may also indicate and/or obtain additional information associated with purchase options 214 prior to receiving the commitment to make the opaque purchase from the user. For example, presentation apparatus 208 may display the number of purchase options 214 and/or a differentiating or shared attribute of purchase options 214 within and/or next to a preview of the opaque purchase that is shown to the user. Presentation apparatus 208 may also include functionality to obtain a user preference of one or more attributes 212 across which the user would like purchase options 214 to be differentiated, and selection apparatus 210 may apply the user preference during selection of purchase options 214. Moreover, the user preference may be implicit, so that purchase options 214 are customized and/or personalized to the user. For example, purchase options 214 may be based on the user's search and/or purchase history with price-differentiation framework 202. Such additional information may mitigate the selection uncertainty and/or reduce the risk associated with committing to the opaque purchase without revealing key details that may be used to identify the travel products associated with the purchase options.

As mentioned above, purchase options 214 may be provided to the user after a commitment to make the opaque purchase is received from the user. For example, presentation apparatus 208 may display a list containing the names, addresses, star ratings, prices, and/or amenities of hotels offered as purchase options 214 for an opaque purchase of a hotel room. If, instead, the opaque purchase is for a flight, presentation apparatus 208 may display a list containing arrival times, departure times, connection times, numbers of stops, airlines, classes of service, and/or prices of flights offered as purchase options 214.

Moreover, presentation apparatus 208 may disclose only attributes (e.g., attributes 212) that differentiate purchase options 214 from one another and continue to withhold details that may be used to identify purchase options 214. For example, presentation apparatus 208 may disclose the prices and amenities offered at each of three hotels without providing the names or addresses of the hotels. Along the same lines, presentation apparatus 208 may present three flights by price and respective departure times in the morning, afternoon, and evening without revealing the specific itineraries of the flights or the airlines operating the flights. By withholding identifying details of purchase options 214 during the user's decision to choose among purchase options 214, price-differentiation framework 202 may present another set of opaque purchases to the user.

Presentation apparatus 208 may then obtain a selection of a purchase option from the user, and processing apparatus 216 may process the opaque purchase with the selection. The user may also be required to meet one or more other conditions associated with the purchase option prior to completing the opaque purchase. For example, the user may be required to provide additional information that can be used for market research purposes, refer one or more other users to price-differentiation framework 202, and/or promote price-differentiation framework 202 and/or the purchase option on a social network. Fulfillment of such conditions may be confirmed by presentation apparatus 208, processing apparatus 216, and/or another component of price-differentiation framework 202.

Consequently, the system of FIG. 2 may preserve the market segmentation associated with opaque sales and allow inventory providers to hide distinguishing product details until a purchase commitment is received. Such opacity may preclude competition with other sales channels of the inventory providers and preserve the existing customer bases of the inventory providers. At the same time, the system of FIG. 2 may allow the users to choose among multiple purchase options 214, thereby providing a better fit to the needs of the users. Price-differentiation framework 202 may thus increase the value of opaque purchases to both the users and the inventory providers.

Those skilled in the art will appreciate that the system of FIG. 2 may be implemented in a variety of ways. First, presentation apparatus 208, selection apparatus 210, processing apparatus 216, rules repository 240, and inventory repository 220 may be provided by a single physical machine, multiple computer systems, one or more virtual machines, a grid, one or more databases, one or more filesystems, and/or a cloud computing system. In addition, presentation apparatus 208, selection apparatus 210, and/or processing apparatus 216 may be implemented together or separately by one or more hardware and/or software components and/or layers.

Second, as mentioned above, inventory and rules associated with travel products and premium travel products may be obtained and/or aggregated from a number of sources. For example, price-differentiation framework 202 may communicate with one or more booking systems, travel suppliers, and/or extranets to obtain travel inventory and/or rules for inclusion in inventory repository 220 and/or rules repository 240, respectively.

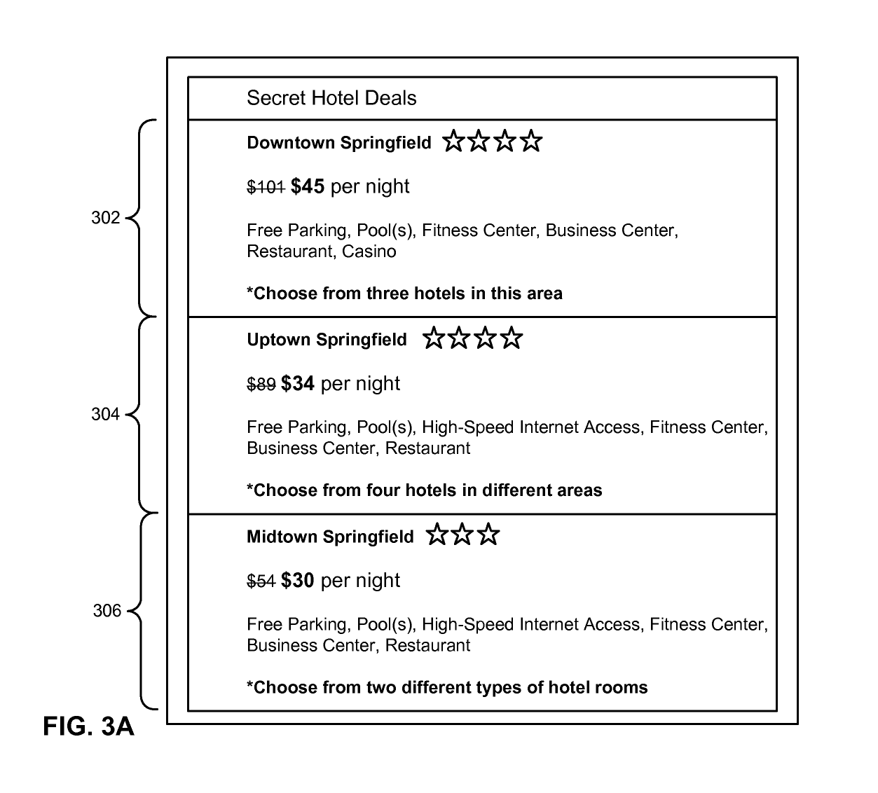

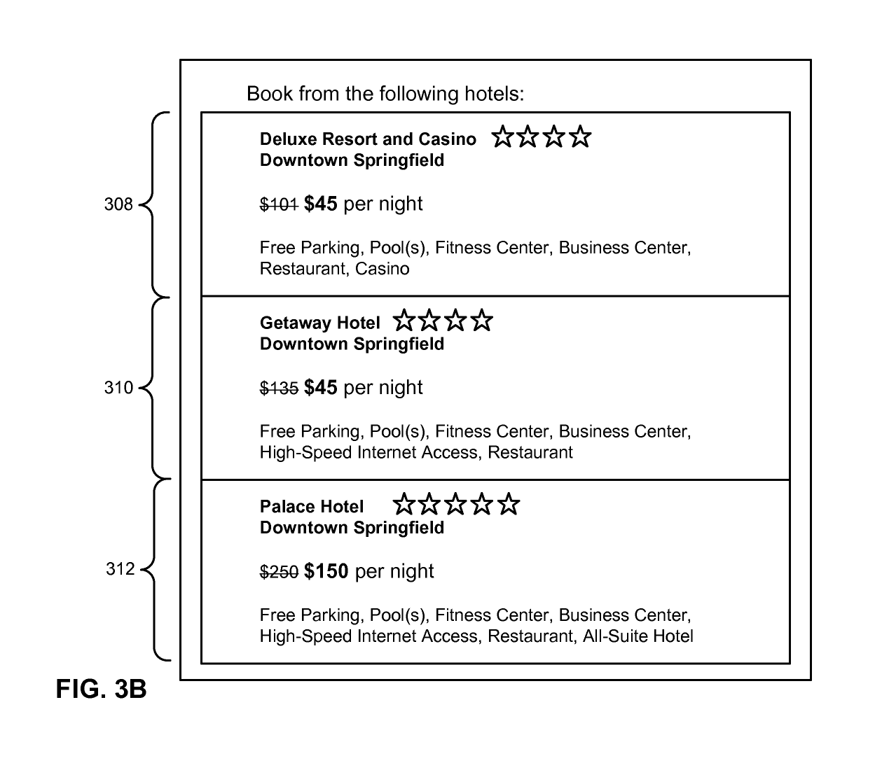

FIG. 3A shows an exemplary screenshot in accordance with the disclosed embodiments. More specifically, FIG. 3A shows a screenshot of a user interface provided by a presentation apparatus, such as presentation apparatus 208 of FIG. 2.

As shown in FIG. 3A, the user interface includes information 302-306 associated with three possible opaque purchases of travel products such as hotel rooms. For example, information 302 may describe a four-star hotel with a geographic area of “Downtown Springfield,” a discounted rate of $45 per night instead of $101 per night, and amenities that include free parking, swimming pools, a fitness center, a business center, a restaurant, and a casino. Information 304 may describe a four-star hotel with a geographic area of “Uptown Springfield,” a discounted rate of $34 per night instead of $89 per night, and amenities that include free parking, swimming pools, high-speed Internet access, a fitness center, a business center, and a restaurant. Information 306 may describe a three-star hotel with geographic area of “Midtown Springfield,” a discounted rate of $30 per night instead of $54 per night, and amenities that include free parking, swimming pools, high-speed Internet access, a fitness center, a business center, and a restaurant. As a result, information 302-306 may be used to offer three travel products at discounted rates to a user without revealing identifying details of the travel products.

Information 302-306 may also include a description of a set of purchase options for each of the opaque purchases. For example, information 302 may indicate the availability of three purchase options in the same area as that of the corresponding opaque purchase (e.g., “Choose from three hotels in this area”). Information 304 may indicate the availability of four purchase options in different areas from that of the corresponding opaque purchase (e.g., “Choose from four hotels in different areas”). Information 306 may specify the availability of two purchase options representing different types of hotel rooms in the hotel associated with the corresponding opaque purchase (e.g., “Choose from two different types of hotel rooms”). The descriptions of the purchase options may thus provide the number of purchase options available for each opaque purchase, as well as an attribute that is common to the purchase options (e.g., same geographic area) or differentiates the purchase options from one another (e.g., different geographic areas, different room types).

By indicating the availability and types of purchase options for each of the opaque purchases, the user interface may reduce the selection uncertainty associated with committing to the opaque purchases. In turn, the user may be more likely to commit to one of the opaque purchases than a user who is not offered a set of purchase options prior to committing to an opaque purchase.

FIG. 3B shows an exemplary screenshot in accordance with the disclosed embodiments. In particular, FIG. 3B shows a screenshot of the user interface of FIG. 3A after the user has committed to making an opaque purchase of the travel product described in information 302. Within the user interface, information 308-312 describing three purchase options is shown.

Like information 302-306 of FIG. 3A, information 308-312 describes the travel products corresponding to the purchase options. First, information 308-312 indicates that all three purchase options are located in the same geographic area (e.g., “Downtown Springfield”), which fits the description of the purchase options in information 302. In addition, one of the purchase options may conform to the terms of the opaque purchase. For example, information 308 may have the same star rating, discounted rate, and amenities as information 302, thus representing the travel product initially offered in the opaque purchase.

On the other hand, the other purchase options may not be required to conform to terms of the opaque purchase. Instead, one or more attributes may vary across the set of purchase options to differentiate the purchase options from one another. For example, information 310 may specify a four-star hotel with a discounted rate of $40 per night instead of $135 per night and amenities that include free parking, swimming pools, a fitness center, a business center, high-speed Internet access, and a restaurant. Information 312 may describe a five-star hotel with a discounted rate of $150 per night instead of $250 per night and amenities that include free parking, swimming pools, a fitness center, a business center, high-speed Internet access, a restaurant, and an all-suite hotel. Consequently, the purchase options may vary in price, star rating, and/or amenities to provide variety in the choices available to the user.

As shown in FIG. 3B, information 308-312 includes identifying details of the purchase options, such as the names of the purchase options (e.g., “Deluxe Resort and Casino,” “Getaway Hotel,” “Palace Hotel”). Such identifying details may allow the user to further research the purchase options prior to completing the opaque purchase with one of the purchase options (e.g., by selecting the region of the user interface containing the information (e.g., information 308-312) for the purchase option). Alternatively, the identifying details may be withheld until after the user has selected a purchase option with which to complete the opaque purchase. Such withholding of identifying details may provide an additional hurdle that provides additional price differentiation in opaque purchases of travel products.

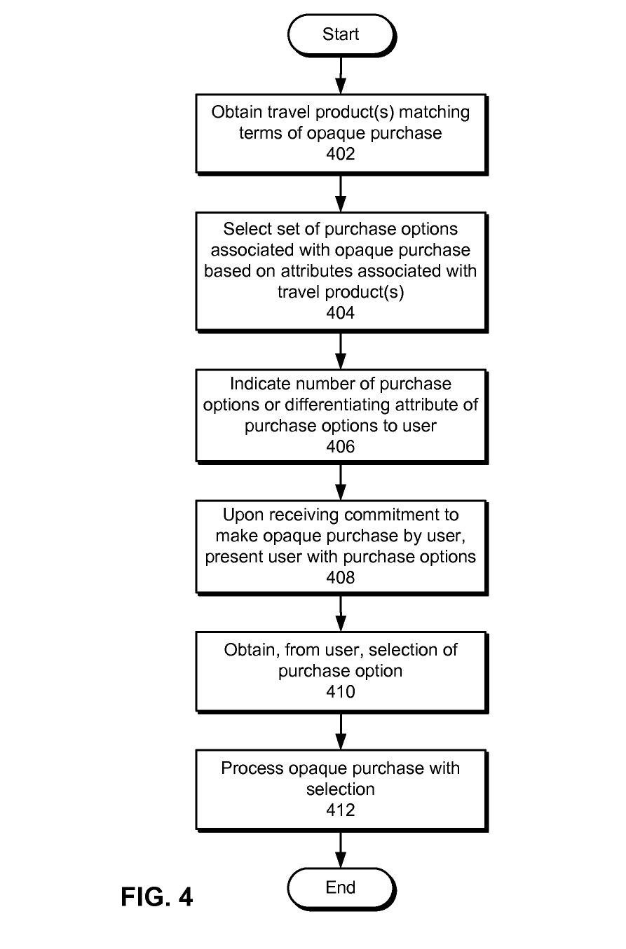

FIG. 4 shows a flowchart illustrating the process of facilitating an opaque purchase that obscures one or more details of a travel product in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, one or more travel products matching the terms of an opaque purchase are obtained (operation 402). The terms may be provided by a user while browsing and/or searching for travel products to book and/or purchase. For example, the user may specify dates, locations, price ranges, star ratings, user ratings, types of travel products, and/or other criteria for filtering the travel products that may be booked through the opaque purchase.

Next, for each travel product matching the terms, a set of purchase options associated with the opaque purchase is selected based on attributes associated with the travel product and/or the user (operation 404). The attributes may include a price, location, quality, brand, type, amenity, supplier, and/or schedule associated with the travel product. The attributes may also include the availability of each of the purchase options and/or a preference of the user. In addition, one or more attributes may be varied across the set of purchase options to differentiate the purchase options from one another. For example, purchase options for flights may vary in price, duration, number of stops, connection points, operating airlines, marketing airlines, departure time, connection time, and/or arrival time. Similarly, purchase options for hotel rooms may vary in price, star rating, location, amenities, and/or hotel room types. Such varying of attributes across the purchase options may be provided by a variety-driven technique and/or set of rules for selecting the purchase options.

The number of purchase options and/or a differentiating attribute of the purchase options are also indicated to the user (operation 406). For example, the user may be notified of the number of purchase options and/or one or more attributes associated with the purchase options (e.g., “includes one or more direct flights for at most $200 extra”) prior to committing to the opaque purchase.

After a commitment to make the opaque purchase by the user is received, the user is presented with the purchase options (operation 408). For example, the user may be shown a list of information that uniquely identifies the purchase options and/or describes the differences in one or more attributes among the set of purchase options. The set of purchase options may include a first purchase option that conforms to the terms of the opaque purchase, as well as one or more additional purchase options that are not required to conform to the terms. For example, the first purchase option may conform to the price of the opaque purchase, while the additional purchase options may be offered at premium prices that are higher than the price of the opaque purchase, or alternatively, discounted prices that are lower than the price of the opaque purchase.

A selection of a purchase option from the available purchase options is then obtained from the user (operation 410), and the opaque purchase is processed with the selection (operation 412). During processing of the opaque purchase, the user may be required to fulfill one or more conditions to complete the opaque purchase. For example, access to the set of purchase options and/or selection of specific purchase options in the set may require the user to pay a higher price than initially shown in the opaque purchase, provide additional information, provide a referral, and/or promote the selected purchase option.

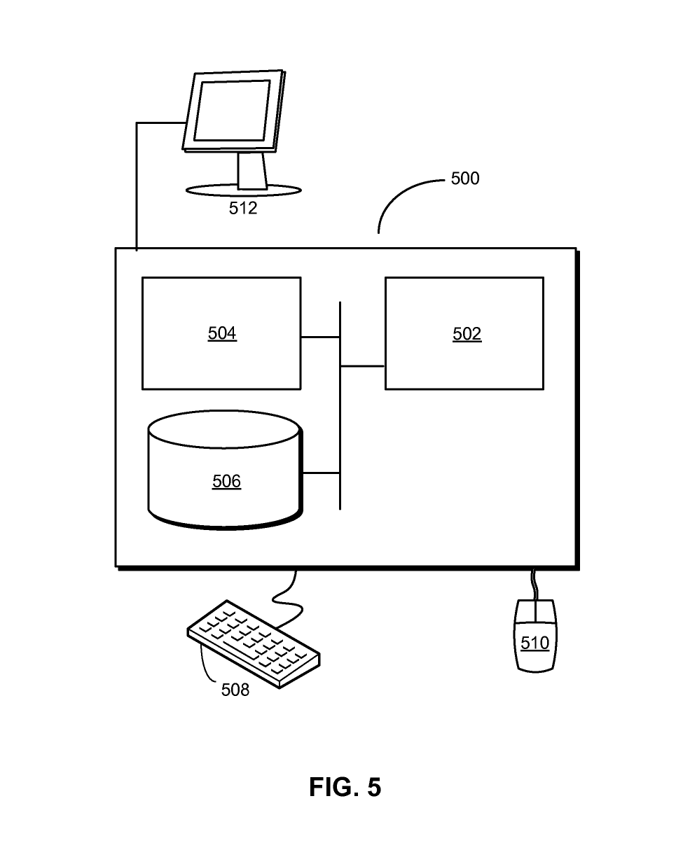

FIG. 5 shows a computer system 500 in accordance with an embodiment. Computer system 500 may correspond to an apparatus that includes a processor 502, memory 504, storage 506, and/or other components found in electronic computing devices such as personal computers, laptop computers, workstations, servers, mobile phones, tablet computers, and/or portable media players. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating an opaque purchase that obscures one or more details of a travel product. The system may include a presentation apparatus. Upon receiving a commitment to make the opaque purchase of the travel product by a user, the presentation apparatus may present the user with a set of purchase options associated with the opaque purchase, including a first purchase option that conforms to one or more terms of the opaque purchase. The presentation apparatus may also obtain, from the user, a selection of a purchase option from the set of purchase options. The system may also include a selection apparatus that selects the set of purchase options based on one or more attributes associated with the travel product. Finally, the system may include a processing apparatus that processes the opaque purchase with the selection.

In addition, one or more components of computer system 500 may be remotely located and connected to the other components over a network. Portions of the present embodiments (e.g., presentation apparatus, selection apparatus, processing apparatus, etc.) may also be located on different nodes of a distributed system that implements the embodiments. For example, the present embodiments may be implemented using a cloud computing system that includes multiple purchase options in opaque purchases to reduce the selection uncertainty associated with the opaque purchases for a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating an opaque purchase that obscures one or more details of a travel product, comprising:
upon receiving a commitment to make the opaque purchase of the travel product by a user, presenting the user with a set of purchase options associated with the opaque purchase, wherein the set of purchase options comprises a first purchase option that conforms to one or more terms of the opaque purchase;
obtaining, from the user, a selection of a purchase option from the set of purchase options; and
processing the opaque purchase with the selection.

2. The computer-implemented method of claim 1, further comprising:
selecting the set of purchase options based on one or more attributes associated with the travel product.

3. The computer-implemented method of claim 2, wherein the one or more attributes comprise at least one of:
a price;
a location;
a quality;
a brand;
a type;
an amenity;
a supplier;
a schedule;
an availability of a purchase option; and
a preference of the user.

4. The computer-implemented method of claim 3, wherein the set of purchase options comprises a second purchase option with a premium price that is higher than the price of the first purchase option.

5. The computer-implemented method of claim 2, wherein selecting the set of purchase options based on the one or more attributes involves:
varying an attribute from the one or more attributes across the set of purchase options.

6. The computer-implemented method of claim 2, wherein presenting the user with the set of purchase options involves:
presenting differences in the one or more attributes among the set of purchase options to the user.

7. The computer-implemented method of claim 1, further comprising:
indicating a number of the purchase options or a differentiating attribute of the purchase options to the user prior to receiving the commitment to make the opaque purchase from the user.

8. The computer-implemented method of claim 1, wherein the set of purchase options comprises a second purchase option that is associated with at least one of:
additional information from the user;
a referral from the user; and
promotion of the second purchase option by the user.

9. The computer-implemented method of claim 1, wherein the travel product is at least one of:
a flight;
a hotel;
a rental car;
a cruise;
a tour; and
a travel package.

10. A system for facilitating an opaque purchase that obscures one or more details of a travel product, comprising:
a presentation apparatus, wherein upon receiving a commitment to make the opaque purchase of the travel product by a user, the presentation apparatus is configured to:
present the user with a set of purchase options associated with the opaque purchase, wherein the set of purchase options comprises a first purchase option that conforms to one or more terms of the opaque purchase; and
obtain, from the user, a selection of a purchase option from the set of purchase options; and
a processing apparatus configured to process the opaque purchase with the selection.

11. The system of claim 10, further comprising:
a selection apparatus configured to select the set of purchase options based on one or more attributes associated with the travel product.

12. The system of claim 11, wherein selecting the set of purchase options based on the one or more attributes involves:
varying an attribute from the one or more attributes across the set of purchase options.

13. The system of claim 11, wherein presenting the user with the set of purchase options involves:
presenting differences in the one or more attributes among the set of purchase options to the user.

14. The system of claim 10, wherein the presentation apparatus is further configured to:
indicate a number of the purchase options or a differentiating attribute of the purchase options to the user prior to receiving the commitment to make the opaque purchase from the user.

15. The system of claim 10, wherein the set of purchase options comprises a second purchase option that is associated with at least one of:
a higher price than the first purchase option;
additional information from the user;
a referral from the user; and
promotion of the second purchase option by the user.

16. A non-transitory computer-readable storage medium storing instructions that when executed by a computer cause the computer to perform a method for facilitating an opaque purchase that obscures one or more details of a travel product, the method comprising:
upon receiving a commitment to make the opaque purchase of the travel product by a user, presenting the user with a set of purchase options associated with the opaque purchase, wherein the set of purchase options comprises a first purchase option that conforms to one or more terms of the opaque purchase;
obtaining, from the user, a selection of a purchase option from the set of purchase options; and
processing the opaque purchase with the selection.

17. The non-transitory computer-readable storage medium of claim 16, the method further comprising:
selecting the set of purchase options based on one or more attributes associated with the travel product.

18. The non-transitory computer-readable storage medium of claim 17, wherein the one or more attributes comprise at least one of:
a price;
a location;
a quality;
a brand;
a type;
an amenity;
a supplier;
a schedule;
an availability of a purchase option; and
a preference of the user.

19. The non-transitory computer-readable storage medium of claim 17, wherein selecting the set of purchase options based on the one or more attributes involves:
varying an attribute from the one or more attributes across the set of purchase options.

20. The non-transitory computer-readable storage medium of claim 16, the method further comprising:
indicating a number of the purchase options or a differentiating attribute of the purchase options to the user prior to receiving the commitment to make the opaque purchase from the user.
